(19) United States
(12) Patent Application Publication
(10) Pub. No.: US 2015/0103184 A1
(43) Pub. Date: Apr. 16, 2015

(54) METHOD AND SYSTEM FOR VISUAL TRACKING OF A SUBJECT FOR AUTOMATIC METERING USING A MOBILE DEVICE

(71) Applicant: Nvidia Corporation, Santa Clara, CA (US)

(72) Inventors: Colin TRACEY, San Jose, CA (US); Nathan LORD, Santa Clara, CA (US); Alexey SPIZHEVOY, Nizhny Novgorod (RU); Andrey KAMAEV, Nizhny Novgorod (RU)

(73) Assignee: Nvidia Corporation, Santa Clara, CA (US)

(21) Appl. No.: 14/054,619

(22) Filed: Oct. 15, 2013

(51) Int. Cl. G01S 3/786

(52) U.S. Cl. CPC G01S 3/7864
USPC 348/169

(57) ABSTRACT

Embodiments of the present invention provide a novel solution that enables mobile devices to continuously track interesting subjects by creating dynamic visual models that can be used to detect and track subjects in-real time through total occlusion or even if a subject temporarily leaves the mobile device's field of view. Additionally, embodiments of the present invention use an online learning scheme that dynamically adjusts tracking procedures responsive to any appearance and/or environmental changes associated with an interesting subject that may occur over a period of time. In this manner, embodiments of the present invention can determine a more optimal focus position that allows movement by either the mobile device or the subject during the performance of auto-focusing procedures and also enables other camera parameters to properly calibrate (meter) themselves based on the focus position determined.

### FIELD OF THE INVENTION

Embodiments of the present invention are generally related to the field of devices capable of image capture.

### BACKGROUND OF THE INVENTION

Conventional mobile devices, such as smartphones and tablets, include the technology to perform a number of different functions. For example, a popular function available on most conventional mobile devices is the ability to take photographs using the camera features of the mobile device. Many sophisticated camera systems included with conventional mobile devices possess metering features that enable them to capture high quality images of subjects that are of interest to the user.

However, when engaging these auto-focusing features, many of these camera systems offer very little flexibility in terms of freedom for users or subjects to move their position during the auto-focusing process. When either the mobile device or subject moves during this process, camera systems will often rely on a focus position that is not properly calibrated towards those subjects that are of interest to the user. As such, these camera systems generally require the mobile device and/or the subject to remain stationary while auto-focusing procedures take place and, thus, are often ill-equipped to capture scenes that involve some degree of motion.

### SUMMARY OF THE INVENTION

Accordingly, a need exists for a solution that allows mobile devices to track arbitrary subjects selected by a user in a given scene through any movement of the mobile device or the subject and determine an optimal focus position for image capture during auto-focusing procedures. Embodiments of the present invention provide a novel solution that enables mobile devices to continuously track interesting subjects by creating dynamic visual models that can be used to detect and track subjects in-real time through total occlusion or even if a subject temporarily leaves the mobile device's field of view. Additionally, embodiments of the present invention use an online learning scheme that dynamically adjusts tracking procedures responsive to any appearance and/or environmental changes associated with an interesting subject that may occur over a period of time. In this manner, embodiments of the present invention can determine a more optimal focus position that allows movement by either the mobile device or the subject during the performance of auto metering procedures and also enables other camera parameters to properly calibrate themselves based on the focus position determined.

More specifically, in one embodiment, the present invention is implemented as a method of adjusting camera parameters for image capture using a mobile device. The method includes, using a camera system, selecting a subject within a field of view of the mobile device during a first time period. In one embodiment, the detecting further includes defining a region of interest using user input, in which the region of interest encapsulates the subject. In one embodiment, the detecting further includes using a classification scheme to detect the subject, in which the classification scheme is a Ferns classification scheme. In one embodiment, the detecting further includes using face detection procedures to detect the subject.

The method also includes generating and storing a visual model on the mobile device responsive to the detecting of the subject, in which the visual model is operable to represent the subject during a second time period in which the subject is outside of the field of view of the mobile device. In one embodiment, the generating further includes updating the visual model in real-time responsive to appearance changes associated with the subject detected over a period of time.

Additionally, the method includes estimating a region of interest for capturing an image of the subject during a third time period by tracking the subject in real-time using the visual model, in which the subject is within the field of view of the mobile device during the third time period. In one embodiment, the tracking further includes calculating a confidence score, in which the tracking further includes determining whether the visual model is updated with new data within an estimated region of interest. Furthermore, the method includes adjusting camera parameters responsive to the region of interest prior to image capture. In one embodiment, the camera parameters include focus and exposure metering parameters. In one embodiment, the method includes capturing an image using the camera parameters.

In one embodiment, the present invention is implemented as a system for adjusting camera parameters for image capture using a mobile device. The system includes a detection module operable to detect a preselected subject identified using user input, in which the preselected subject is within a field of view of the mobile device during a first time period. In one embodiment, the detection module is further operable to receive data associated with a region of interest defined by a user, in which the region of interest encapsulates the preselected subject. In one embodiment, the detection module is further operable to use a classification scheme to detect the preselected subject, in which the classification scheme is a Ferns classification scheme.

The system also includes a model generation module operable to generate and store a visual model in memory resident on the mobile device responsive to a detection of the preselected subject, in which the visual model is operable to represent the preselected subject during a second time period in which the preselected subject is outside of the field of view of the mobile device.

Additionally, the system includes a tracking module operable to estimate a region of interest for capturing an image of the preselected subject during a third time period by tracking the preselected subject in real-time using the visual model, in which the preselected subject is within the field of view of the mobile device during the third time period. In one embodiment, the tracking module is further operable to calculate a confidence score to determine whether to update a previously estimated focus position calculated for the preselected subject using updated coordinate data provided by the visual model. Furthermore, the system includes an adjustment module operable to adjust camera parameters responsive to the region of interest prior to image capture. In one embodiment, the camera parameters include focus and exposure metering parameters. In one embodiment, the system includes an image capture module operable to capture an image using the camera parameters.

In one embodiment, the present invention is implemented as a method for capturing an image using a mobile device. The method includes, using a camera system, detecting a first subject within a field of view of the mobile device during a first time period. In on embodiment, the detecting further includes defining a region of interest using user input, in which the region of interest encapsulates the first subject. In one embodiment, the detecting further includes using a classification scheme to detect the first subject, in which the classification scheme is a Ferns classification scheme.

Also, the method includes generating and storing a first visual model on the mobile device responsive to a detection of the first subject, in which the first visual model is operable to represent the first subject during a second time period in which the first subject is outside of the field of view of the mobile device. In one embodiment, the generating further comprises updating the first visual model in real-time responsive to appearance changes associated with the first subject detected over a period of time.

Additionally, the method includes estimating a first focus position for capturing an image of the first subject during a third time period by tracking the first subject in real-time using the first visual model, in which the first subject is within the field of view of the mobile device during the third time period. In one embodiment, the tracking further includes calculating a confidence score to determine whether to update a previously estimated focus position calculated for the first subject using updated coordinate data provided by the first visual model. Furthermore, the method includes adjusting camera parameters responsive to the first optimal focus position prior to image capture. In one embodiment, the camera parameters comprise focus and exposure metering parameters.

In one embodiment, the method further includes, using the camera system, detecting a second subject within the field of view of the mobile device during the first time period. In one embodiment, the method further includes generating and storing a second visual model on the mobile device responsive to a detection of the second subject, in which the second visual model is operable to represent the second subject during the second time period in which the second subject is outside of the field of view of the mobile device. In one embodiment, the method further includes estimating a second focus position for capturing an image of the second subject during the third time period by tracking the second subject in real-time using the second visual model, in which the second subject is within the field of view of the mobile device during the third time period. In one embodiment, the method further includes adjusting camera parameters responsive to the second optimal focus position prior to the image capture. The method also includes capturing the image using the camera parameters.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 depicts an exemplary system in accordance with embodiments of the present invention.

FIG. 2 depicts an exemplary subject detection process using a camera system that is performed during automatic focusing procedures in accordance with embodiments of the present invention.

FIG. 3 depicts an exemplary data structure capable of storing visual model data during the performance of automatic focusing procedures in accordance with embodiments of the present invention.

FIG. 4 depicts an exemplary subject tracking process that is performed during automatic focusing procedures in accordance with embodiments of the present invention.

FIG. 5A depicts an exemplary subject detecting and tracking process performed during automatic focusing procedures in accordance with embodiments of the present invention.

FIG. 5B depicts another exemplary subject detecting and tracking process performed during automatic focusing procedures in accordance with embodiments of the present invention.

FIG. 5C depicts yet another exemplary subject detecting and tracking process performed during automatic focusing procedures in accordance with embodiments of the present invention.

FIG. 6 is a flow chart depicting an exemplary visual subject tracking process for use in automatic focusing procedures in accordance with embodiments of the present invention.

FIG. 7 is another flow chart depicting an exemplary visual face tracking process for use in automatic focusing procedures in accordance with embodiments of the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

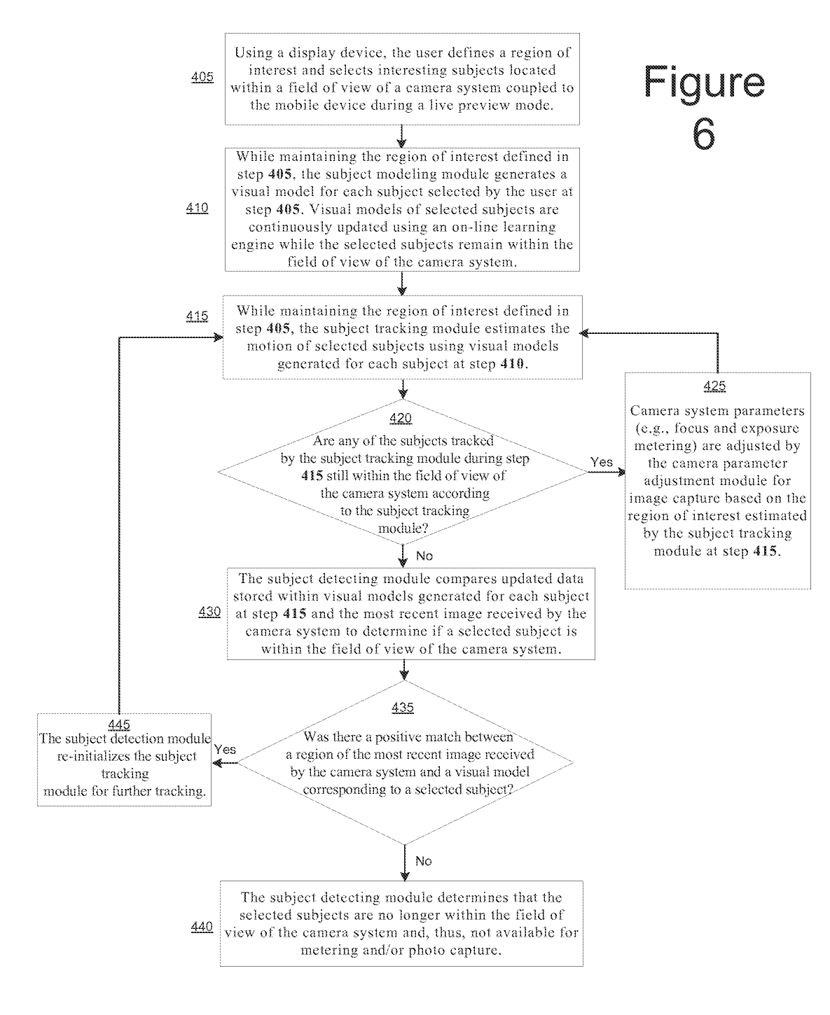

Portions of the detailed description that follow are presented and discussed in terms of a process. Although operations and sequencing thereof are disclosed in a figure herein (e.g., FIG. 6A, 6B, 7, etc.) describing the operations of this process, such operations and sequencing are exemplary. Embodiments are well suited to performing various other operations or variations of the operations recited in the flowchart of the figure herein, and in a sequence other than that depicted and described herein.

As used in this application the terms controller, module, system, and the like are intended to refer to a computer-related entity, specifically, either hardware, firmware, a combination of hardware and software, software, or software in execution. For example, a module can be, but is not limited to being, a process running on a processor, an integrated circuit, an subject, an executable, a thread of execution, a program, and or a computer. By way of illustration, both an application running on a computing device and the computing device can be a module. One or more modules can reside within a process and/or thread of execution, and a component can be localized on one computer and/or distributed between two or more computers. In addition, these modules can be executed from various computer readable media having various data structures stored thereon.

### Exemplary System in Accordance with Embodiments of the Present Invention

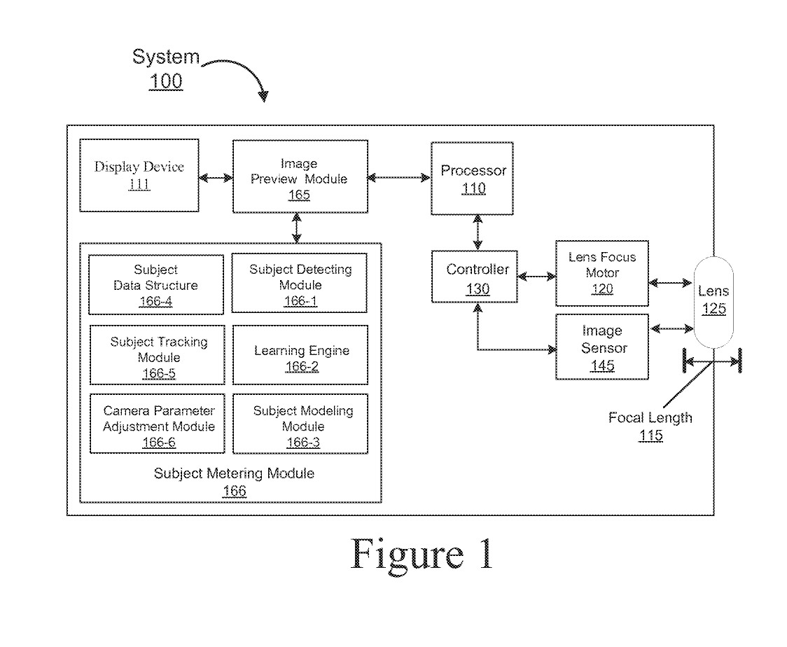

As presented in FIG. 1, an exemplary system 100 upon which embodiments of the present invention may be implemented is depicted. System 100 can be implemented as, for example, a digital camera, cell phone camera, portable electronic device (e.g., audio device, entertainment device, handheld device), webcam, video device (e.g., camcorder) and the like. As illustrated in the embodiment depicted in FIG. 1, system 100 may comprise lens 125, lens focus motor 120, image sensor 145, controller 130, image processor 110, image preview module 165 and display device 111 and subject metering module 166. In one embodiment, subject metering module 166 may comprise subject detecting module 166-1, learning engine 166-2, subject modeling module 166-3, subject data structure 166-4, subject tracking module 166-5 and camera parameter adjustment module 166-6. Additionally, components of system 100 may be coupled via internal communications bus and may receive/transmit image data for further processing over such communications bus. Furthermore, embodiments of the present invention may be operable to process instructions using SIMD, ARM Neon systems or other multi-threading/multi-core processing architectures.

Subject metering module 166 may be operable to continuously track interesting subjects, irrespective of motion detected within a given scene. In one embodiment, subject metering module 166 may operate in memory resident on system 100. As illustrated by the embodiment depicted in FIG. 1, subject metering module 166 may be operable to receive image data associated with external scenes captured through lens 125. Lens 125 may be placed in a position determined by controller 130, which uses focus motor 120 as a mechanism to position lens 125. As such, focus motor 125 may be operable to move lens 125 along lens focal length 115, which may result in varying degrees of focus quality (e.g., sharpness). According to one embodiment, image sensor 145 may comprise an array of pixel sensors operable to gather image data from scenes external to system 100 via lens 125. Image sensor 145 may also include the functionality to capture and convert light received via lens 125 into signal data (e.g., digital or analog) capable of being processed by image processor 110. Although system 100 depicts only lens 125 in the FIG. 1 illustration, embodiments of the present invention may support multiple lens configurations and/or multiple cameras (e.g., stereo cameras).

Image data gathered from image sensor 145 may then be passed to image preview module 165 for further processing. Image preview module 165 may include the functionality to communicate a stream of video data signals to display device 111 using image data processed by image processor 110. For example, in one embodiment, image sensor 145 may provide image processor 110 with image data (e.g., pixel data) associated with scenes captured via lens 125 at various times. Upon completion of image processing operations on the acquired image data, image processor 110 may use instructions received from image preview module 165 to output the processed image data into memory buffers (not pictured) located in memory resident on system 100. In one embodiment, image preview module 165 may include the functionality to retrieve data stored in the memory buffers and encode the image data processed by image processor 110 into video data signals capable of being processed and displayed by display device 111. In this manner, image preview module 165 may be used by display device 111 to provide a user with a live preview of a given scene that includes interesting subjects prior to taking a photograph.

Display device 111 may include the functionality to receive video data signals from image preview module 165 and display corresponding output. Examples of display device 111 may include, but are not limited to, a liquid crystal display (LCD), a plasma display, etc. In one embodiment, display device 111 may be a touch-sensitive display device (e.g., electronic touch screen display device) capable of detecting and processing touch events. For example in one embodiment, display device 111 may be operable to process sampling point data associated with touch events performed on display device 111 and make the data available for further processing by other components of system 100. Sampling point data may provide locational information (e.g., touch event coordinates) regarding where contact is made with display device 111. Furthermore, touch events may be provided by sources such as fingers or instruments capable of making contact with a touch surface (e.g., a stylus). Display device 111 may also include the functionality to capture multiple touch events simultaneously.

Display device 111 may also include the functionality to enable a user to select an interesting subject displayed during a live preview mode for tracking purposes. For instance, in one embodiment, display device 111 may be operable to display a GUI during a live preview mode in a manner that displays a selectable subject or a group of selectable subjects that may be selected by the user for tracking purposes. Furthermore, in one embodiment, display device 111 may also include the functionality to enable the user to define regions of interest (“ROI”) during a live preview mode in a manner that enables the user to define a region of interest that includes a particular subject or group of subjects that are of interest to the user. For instance, configurable attributes associated with a region of interest that may be defined by a user may include, but are not limited to offset x parameters, offset y parameters, width parameters, height parameters, etc. In this manner, a user may use the GUI displayed within display device 111 to define a set of attributes associated with a region of interest to include a particular subject or group of subjects that are of interest to the user.

Also, in one embodiment, the user may be able to define attributes using optional input devices coupled to system 100. For example, optional input devices may include, but are not limited to, control pads, joysticks, keyboards, mice, etc. In one embodiment, display device 111 may be a touch-sensitive device configured to enable a user to highlight regions of interest using the touch-sensitive features of display device 111. As such, the user may be able to define attributes via touch input provided through display device 111. For example, the user may make direct contact with display device 111 (e.g., using a finger or stylus) to highlight a region of interest. Accordingly, display device 111 may record the touch input sampling points associated with the region of interest defined by the user in memory resident on system 100 for further processing by components of system 100.

Subject detection module 166-1 may include the functionality to scan and process image data associated with frames received from image sensor 145 to detect interesting subjects. For example, according to one embodiment, subject detecting module 166-1 may include the functionality to compute the pixel values of various image subsections (“subsections”) within frames received from image sensor 145. In one embodiment, subject detecting module 166-1 may be configured to process subsections of various shapes and/or sizes in parallel. In this manner, subject detecting module 166-1 may be operable to compute pixel values of various image subsections within a region of interest defined by a user. Furthermore, according to one embodiment, subject detecting module 166-1 may include the functionality to detect interesting subjects within subsections using visual models generated by subject modeling module 166-3 and updated by learning engine 166-2.

Learning engine 166-2 may include the functionality to use well-known image classification procedures (e.g., cascade classifiers) to train subject detecting module 166-1 to detect interesting subjects within frames received from image sensor 145. In one embodiment, learning engine 166-2 may be trained during an on-line mode (e.g., using unsupervised learning procedures, semi-supervised learning procedures, etc.) which it enables subject metering module 166 to dynamically track and/or detect arbitrary subjects with no a priori knowledge of the detected interesting subjects. As such, subject detecting module 166-1 may be operable to detect subjects within frames received from image sensor 145 using classifiers employed by an on-line classification scheme implemented by learning engine 166-2.

For instance, according to one embodiment, classifiers may be configured to measure specific features of a particular subsection (e.g., data clusters associated with a particular subject) and provide feedback to subject detecting module 166-1. For example, classifiers may measure a set of features within a particular subsection and provide positive feedback (e.g., outputting a “1”) to subject detecting module 166-1 if the subsection is likely to include an interesting subject (e.g., a detectable portion of an interesting subject) and negative feedback (e.g., outputting a “0”) to subject detecting module 166-1 if the subsection is not likely to include an interesting subject.

Based on the collective determinations made by classifiers, subject detecting module 166-1 may be capable of determining the likely presence and current location (e.g., pixel coordinates) of an interesting subject detected. According to one embodiment, subject detecting module 166-1 may be capable of using a cascade classification scheme (e.g., Ferns classification scheme) in which subject detecting module 166-1 may determine the presence of subjects using a multi-stage approach. Additionally, in one embodiment, subject detecting module 166-1 may be capable of utilizing histogram matching procedures (e.g., color histograms) which may also improve the robust learning and/or training capabilities of learning engine 166-2. In one embodiment, learning engine 166-2 may be configured to identify subjects based on a set of training data provided to learning engine 166-2 during an off-line mode (e.g., using pre-computed classifiers trained off-line for face detection, object detection, etc.). For instance, in one embodiment, during an off-line mode, learning engine 166-2 may provide feedback to users concerning likely subjects to track. In one embodiment, learning engine may be capable of learning a plurality of different subject classes including, but not limited to, animals, vehicles, famous landmarks, etc.

Subject modeling module 166-3 may include the functionality to generate visual models capable of enabling subject metering module 166 to maintain continuous focus on interesting subjects detected, irrespective of occlusion or the subject periodically leaving system 100's field of view. For example, according to one embodiment, subject modeling module 166-3 may include the functionality to generate visual models using coordinate data points associated with subsections determined by subject detecting module 166-1 to likely include an interesting subject. As such, in one embodiment, visual models generated by subject modeling module 166-3 may represent as a set of multi-dimensional coordinate data (e.g., 2 dimensional pixel coordinates, 3 dimensional pixel coordinates, etc.) associated with each interesting subject detected by subject detecting module 166-1. Furthermore, visual model data may be stored within a data structure resident on system 100 (e.g., subject data structure 166-4) that is accessible to other components of system 100.

Furthermore, in one embodiment, visual models generated by subject modeling module 166-3 may be continuously updated in real-time (e.g., using learning engine 166-2) as new frames are received and processed by components of system 100. According to one embodiment, subject detecting module 166-1 may also include the functionality to detect changes in the appearance of detected subjects over time (e.g., subjects already recognized by subject detecting module 166-1 and modeled via subject modeling module 166-3). For example, in one embodiment, subject detecting module 166-1 may be configured to recognize scaled and/or rotational representations of detected subjects. In this manner, subject detecting module 166-1 may also be configured to receive continuously updated visual models from learning engine 166-2.

Additionally, subject detecting module 166-1 may also include the functionality to detect environmental changes surrounding detected subjects over time. For example, in one embodiment, subject detecting module 166-1 may be configured to recognize changes in brightness levels surrounding detected subjects (e.g., transition from dim lighting to bright lighting). As such, learning engine 166-2 may also be capable actively learning how to recognize such changes during an on-line learning mode. Accordingly, subject modeling module 166-3 may be capable of continuously updating visual models stored in subject data structure 166-4 in real-time upon recognition of appearance and/or environmental changes associated with previously detected subjects.

Subject tracking module 166-5 may include the functionality to track the motion of detected subjects using frame data received from image sensor 145 as well as visual model data stored in subject data structure 166-4 and estimate an optimal focus position for lens 125 to capture interesting subjects. For example, according to one embodiment, subject tracking module 166-5 may retrieve a set of coordinate data points associated with a detected subject that were gathered during an initial detection of the subject (e.g., data gathered from the first frame or set of frames in which subject detecting module 166-1 detected the subject for the first time). Coordinate data points used by subject tracking module 166-5 may be accessible through visual models generated for each subject detected by subject detecting module 166-1 and stored in subject data structure 166-4 or another memory location resident on system 100 capable of storing the coordinate data.

Subject tracking module 166-5 may then correlate coordinate data points retrieved within a set of subsequent frames (e.g., consecutive frames) received from image sensor 145 over a period of time to estimate a future position or trajectory for each subject detected by subject detecting module 166-1. As such, subject metering module 166 may send instructions to controller 130 to position lens 125 for focusing based on the estimated positions calculated by subject tracking module 166-5. According to one embodiment, subject tracking module 166-5 may be configured to utilize median flow tracking procedures to perform tracking operations.

Furthermore, subject tracking module 166-5 may be operable to perform tracking operations in a synchronous manner with other components of system 100 (e.g., subject detecting module 166-1, subject modeling module 166-3, etc.) such that the effect of drift is minimized. For instance, according to one embodiment, subject detecting module 166-1 may periodically calculate a confidence score which represents how well the coordinate data values correlate or match each other within the set of frames analyzed by subject tracking module 166-5. In this manner, subject detecting module 166-1 may compute high confidence scores for a positive detection of an interesting subject, at which point, in one embodiment, subject detecting module 166-1 may override and/or re-initialize subject tracking module 166-5 to continue performance of tracking operations on previously detected subjects.

.

According to one embodiment, subject modeling module 166-3 may make visual model data accessible as metadata for use in further processing by components of system 100 (e.g., camera parameter adjustment module 166-6). As such, camera parameter adjustment module 166-6 may include the functionality to read metadata made available by subject modeling module 166-3 and correspondingly adjust various camera parameters responsive to a current estimated focus position determined by subject tracking module 166-5. In one embodiment, camera parameters that may be adjusted by camera parameter adjustment module 166-6 may include, but are not limited to, focus and exposure metering parameters (e.g., setting exposure levels based on ROI), shutter speed parameters, color or white balance parameters, and the like.

For example, in one embodiment, subject data structure 166-4 may be operable to store metadata capable tracking the rate of speed in which detected subjects move around within a given scene prior to image capture. As such, camera parameter adjustment module 166-6 may read this metadata and correspondingly adjust shutter speed parameters in manner that enhances a resultant image output. In this manner, camera parameter adjustment module 166-6 may also adjust other camera parameters accordingly in order to produce high quality resultant image.

Also, according to one embodiment, the scalability of subjects may be visually tracked using data (e.g., 3 dimensional coordinate data) stored in subject data structure 166-4. In this manner, embodiments of the present invention may be capable of determining how far away an interesting subject may be relative to system 100 (“subject depth”). Also, in one embodiment, subject depth may be visually tracked by a user using via geometric shapes displayed via display device 111. For example, in one embodiment, a rectangle encapsulating a detected subject may proportionally increase in size as the subject approaches system 100 and decrease in size as the subject moves further away from system 100.

Embodiments of the present invention may also be configured to continuously detect and track subjects for a pre-determined period of time. According to one embodiment, system 100 may be configured to return to a default focusing mode after a detected subject leaves system 100's field of view for a pre-determined period of time. As such, when a previously detected subject is not seen for a pre-determined period of time, a user may re-engage system 100 to re-focus on the previously detected subject if so desired.

Embodiments of the present invention may also be operable to detect the presence of interesting faces that are captured within scenes using well-known face detection and/or face recognition procedures. Using these procedures, subject detecting module 166-1 may be operable to gather data regarding the relative position, shape and/or size of various detected facial features including cheek bones, nose, eyes, and/or the jaw bone. Furthermore, in one embodiment, subject detecting module 166-1 may be capable of being trained by learning engine 166-2 to recognize different facial features associated with faces detected. Additionally, in one embodiment, subject modeling module 166-3 may also include the functionality to generate and/or store visual models based on faces detected by subject detecting module 166-1. As such, subject modeling module 166-3 may also include the functionality to continuously update visual models associated with faces detected in real-time in response to data gathered by components of system 100 (e.g., subject detecting module and/or subject tracking module 166-3) in a manner similar to embodiments described herein.

Additionally, embodiments of the present invention may be operable to recognize subjects based on the frequency in which system 100 detects the subject. For example, according to one embodiment, visual models that are frequently generated by subject modeling module 166-3 may be stored in a more permanent memory location resident on system 100 such that subjects associated with the frequently generated models may be detected and tracked by embodiments of the present invention without user assistance (e.g., without the user defining a region of interest). Furthermore, embodiments of the present invention may support the importing/exporting of visual models to additional systems similar to system 100 using portable memory storage mediums or over a communications network.

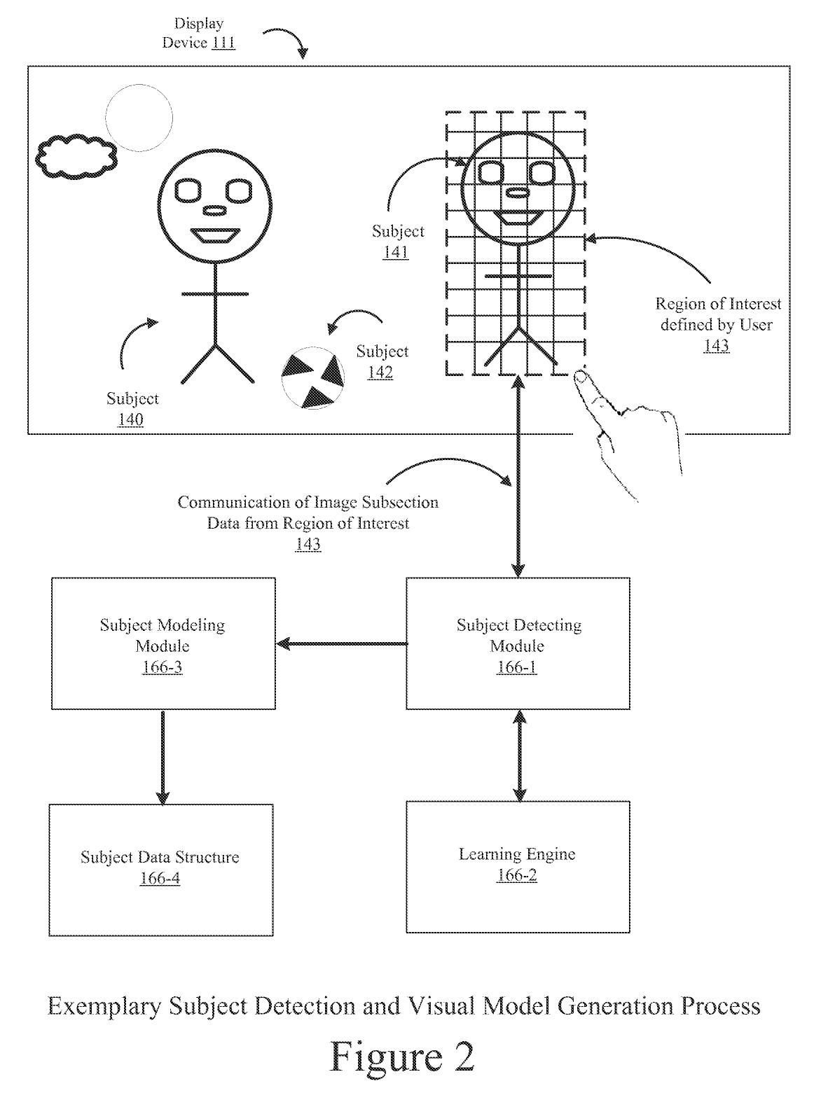

FIG. 2 depicts an exemplary subject detection process using a camera system that is performed during automatic focusing procedures in accordance with embodiments of the present invention. As illustrated in FIG. 2, a user may be able to highlight a region of interest (e.g., region of interest 143) using the touch-sensitive features of display device 111. As such, the user may be able to define the boundaries of region of interest 143 via touch input provided via display device 111 by making direct contact with display device 111 (e.g., using a finger). Accordingly, display device 111 may record the touch input sampling points associated with region of interest 143 defined by the user in memory resident on system 100 for further processing by components of system 100.

Additionally, as illustrated in FIG. 2, subject detecting module 166-1 may compute pixel values of subsections within region of interest 143 defined by the user. Statistical data associated with the pixel data computed by subject detection module 166-1 may then be fed to learning engine 166-2 for further processing. Learning engine 166-2 may then proceed to use well-known image classification procedures (e.g., cascade classifiers) to assist subject detecting module 166-1 in detecting subject human subject 141 within the bounds of region of interest 143. In assisting subject detecting module 166-1, learning engine 166-2 may identify human subject 141 based on a set of training data provided to learning engine 166-2 during an off-line mode. Although a human subject was detected in the embodiment depicted in FIG. 2, it should be appreciated that embodiments of the present invention may be operable to detect non-human subjects (e.g., soccer ball 142).

Furthermore, as illustrated by the embodiment depicted in FIG. 2, subject modeling module 166-3 may generate a visual model of human subject 141 upon its detection which may include multi-dimensional coordinate data (e.g., 2 dimensional coordinates, 3 dimensional coordinates, etc.) associated with human subject 141's current position that may then be stored within subject data structure 166-4. Furthermore, as depicted by the bi-directional arrows between the region of interest 143 and subject detecting module 166-1, models generated by subject detecting module 166-1 may be continuously updated in real-time as new frames are received and processed by components of system 100.

Also, as depicted by the bi-directional arrows between subject detecting module 166-1 and learning engine 166-2, learning engine 166-2 may be configured to recognize perceived appearance and/or environmental changes associated with human subject 141 based training data gathered during an on-line learning mode (e.g., using unsupervised learning procedures, semi-supervised learning procedures, etc.). As such, classifiers used by subject detecting module 166-1 to detect human subject 141 may be configured to continuously receive updated training from learning engine 166-2. For example, with reference to the FIG. 2 illustration, momentary changes in brightness levels may be caused by clouds blocking the sun and may result in a perceived change in the appearance of human subject 141. As such, subject detecting module 166-1 may receive continuously updated training from learning engine 166-2 which helps in recognizing human subject 141, despite these perceived changes. Furthermore, subject detecting module 166-1 may continue to update the visual model stored in subject data structure 166-4 in real-time responsive to any detected movements made by human subject 141.

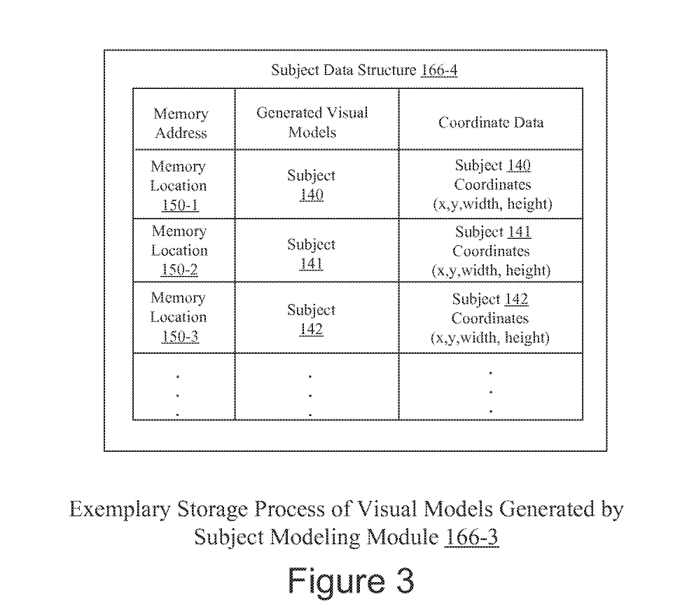

FIG. 3 depicts an exemplary data structure capable of storing visual model data during the performance of automatic focusing procedures in accordance with embodiments of the present invention. As illustrated in FIG. 3, data stored in subject data structure 166-4 may consist of coordinate data, including width and/or height data associated with detect subjects recognized by system 100 (e.g., subjects 140, 141, 142, etc.). Furthermore, as illustrated in FIG. 3, each detected subject may be mapped to location in memory (e.g., memory locations 150-1, 150-2, 150-3, 150-4, etc.). In this manner, system 100 may use data stored in subject data structure 166-4 to maintain or re-engage in the continuous tracking of human subject 141 in the event of occlusion or if human subject 141 momentarily leaves system 100's field of view. According to one embodiment, data stored in subject data structure 166-4 may include various representations of subjects detected by system 100 including scaled representations, rotated representations, etc. Also, according to one embodiment, subject data structure 166-4 may also enable any metadata stored to be accessible to various components (e.g., camera parameter adjustment module 166-6) and/or applications resident on system 100 for further processing. Furthermore, in one embodiment, labels used to classify and detect subjects/and scenes may be stored in subject data structure 166-4 and may also be made available to various components and/or applications resident on system 100.

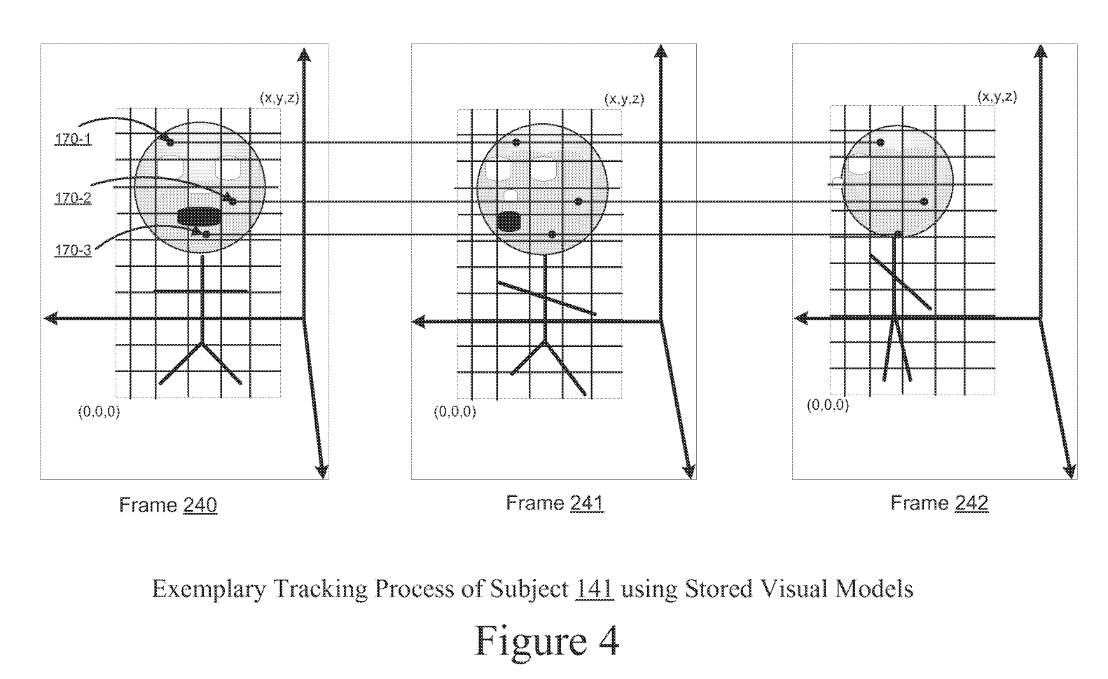

FIG. 4 depicts an exemplary subject tracking process that is performed during automatic focusing procedures in accordance with embodiments of the present invention. As illustrated in FIG. 4, subject tracking module 166-5 may retrieve a set of subsection data points (e.g., data points 170-1, 170-2, 170-3) associated with detected human subject 141 stored in subject data structure 166-4 that were gathered during an initial detection of human subject 141 (e.g., data gathered from frame 240 in which subject detecting module 166-1 detected human subject 141 for the first time). Subject tracking module 166-5 may then map those data points (e.g., data points 170-1, 170-2, 170-3) within a set of subsequent frames (e.g., frames 240, 241, 242) received from image sensor 145 over a period of time to estimate future positions of the detected subject and periodically calculate a confidence score that represents how well the subsections match each other within the frames analyzed.

Also, as illustrated in FIG. 4, subject detecting module 166-1 may detect changes in the appearance of subject 141 over time (e.g., depicted as changes in human subject 141's rotation within frames 240, 241, 242, respectively). As such, subject detecting module 166-1 may continuously update the visual model associated with human subject 141 in real-time responsive to these changes. As such, subject tracking module 166-5 may adjust previous estimations made for human subject 141 using updated values provided by the visual model associated with human subject 141 should a confidence score calculated by subject tracking module 166-5 fall below a pre-determined threshold value.

With further reference to the embodiment depicted in FIG. 4, the scalability of subjects may be tracked using data stored in subject data structure 166-4. For example, coordinate data calculated for human subject 141 may include how far away human subject 141 may be relative to system 100 (e.g., represented as a third coordinate within frames 240, 241, 242). As such, in one embodiment, subject depth may be stored in subject data structure 166-4 and also visually tracked via display device 111. For example, in one embodiment, the relative position of a human subject 141 with respect to system 100 may be visually displayed via geometric shapes (e.g., rectangle encapsulating human subject 141) displayed within display device 111. As such, a rectangle encapsulating human subject 141 may proportionally increase in size as it approaches system 100 and decrease in size as it moves further away from system 100.

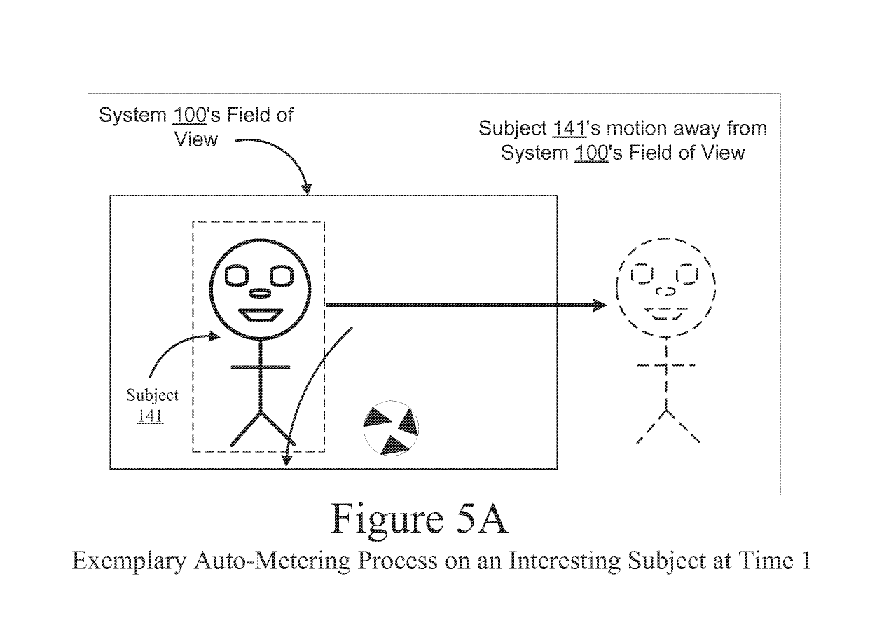

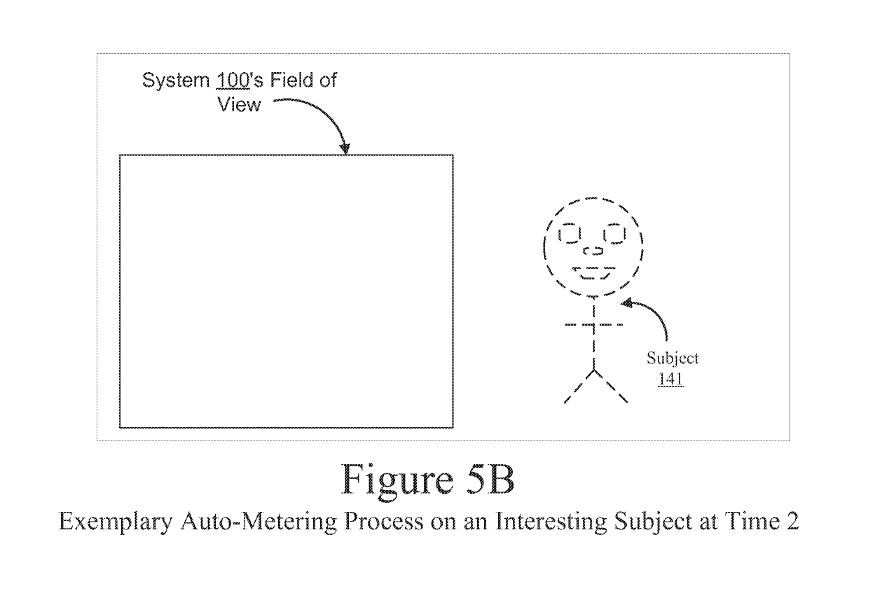

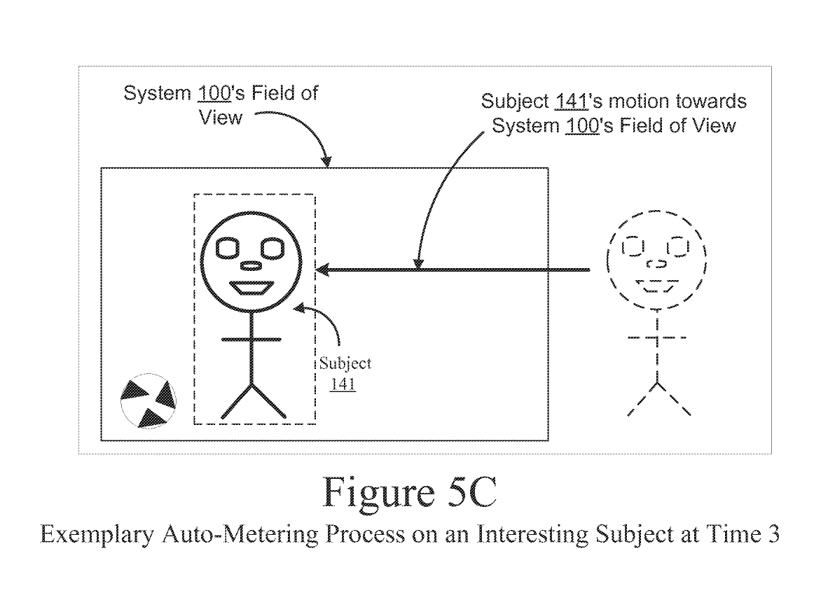

FIGS. 5A, 5B and 5C depict exemplary subject detecting and tracking processes performed during automatic focusing procedures in accordance with embodiments of the present invention. With reference to the embodiment depicted in FIG. 5A, system 100 may initially detect human subject 141 within system's 100 field of view using subject detecting module 166-1 and/or learning engine 166-2 at Time 1. As described herein, upon detection of human subject 141 at Time 1, subject modeling module 166-3 may immediately generate a visual model of human subject 141 which may then be stored and continually updated in-real time within subject data structure 166-4, including up to the point human subject 141 begins to leave system 100's field of view.

Furthermore, subject tracking module 166-5 may track human subject 141 using data points associated with its stored visual model and periodically calculate a confidence score to determine whether adjustments are to be made to a previous estimated trajectory calculation. The confidence score calculated by subject tracking module 166-5 may represent how well the data points associated with human subject 141 correlate to each other within subsequent frames received from image sensor 145. For situations in which the confidence score falls below a pre-determined threshold value, subject tracking module 166-5 may be configured to reference the visual model data associated with human subject 141 to continuously maintain a more accurate tracking position during the performance of tracking operations. In this manner, the confidence score used by subject tracking module 166-5 may determine whether a visual model is updated (e.g, trained) with new data within an estimated region of interest

For example, with reference to the embodiment depicted in FIG. 5A, as human subject 141 leaves system 100's field of view and then completely out of system 100's field of view (e.g., see FIG. 5B), subject tracking module 166-5 may begin to calculate lower confidence scores, which may eventually reach a pre-determined threshold value that alerts subject tracking module 166-5 that its current estimation of human's subject 141's trajectory may be inaccurate.

With reference to the embodiment depicted in FIG. 5C, using the updated visual model data associated with human subject 141 stored in subject data structure 166-4, subject tracking module 166-1 may more accurately re-engage in continuous detection and tracking of human subject 141 upon its return within system's 100 field of view at Time 2 so that a user may obtain a better automatic focus position to capture an image of human subject 141. It may be appreciated that the embodiments depicted in FIGS. 5A, 5B and 5C may depict time differences (e.g., the difference between Time 1 and Time 2) as milliseconds, microseconds, etc.

FIG. 6 presents a flowchart which describes an exemplary visual tracking process of interesting subjects for use in automatic focusing procedures in accordance with embodiments of the present invention.

At step 405, using a display device, the user defines a region of interest and selects interesting subjects located within a field of view of a camera system coupled to the mobile device during a live preview mode.

At step 410, while maintaining the region of interest defined in step 405, the subject modeling module generates a visual model for each subject selected by the user at step 405. Visual models of selected subjects are continuously updated using an on-line learning engine while the selected subjects remain within the field of view of the camera system.

At step 415, while maintaining the region of interest defined in step 405, the subject tracking module estimates the motion of selected subjects using visual models generated for each subject at step 410.

At step 420, a determination is made as to whether any of the subjects tracked by the subject tracking module during step 415 are still within the field of view of the camera system according to the subject tracking module. If a subject tracked by the subject tracking module is still within the field of view according to the subject tracking module, then camera system parameters (e.g., focus and exposure metering) are adjusted by the camera parameter adjustment module for image capture based on the region of interest estimated by the subject tracking module at step 415, as detailed in step 425. If a subject tracked by the subject tracking module is not within the field of view according to the subject tracking module, then the subject detecting module compares updated data stored within visual models generated for each subject at step 415 and the most recent image received by the camera system to determine if a selected subject is within the field of view of the camera system, as detailed in step 430.

At step 425, a subject tracked by the subject tracking module remains within the field of view of the camera system according to the subject tracking module and, therefore, camera system parameters (e.g., focus and exposure metering) are adjusted by the camera parameter adjustment module for image capture based on the region of interest estimated by the subject tracking module at step 415. Furthermore, the tracking module proceeds to perform tracking operations as described in step 415.

At step 430, a subject tracked by the subject tracking module no longer remains within the field of view of the camera system according to the subject tracking module and, therefore, the subject detecting module compares updated data stored within visual models generated for each subject at step 415 and the most recent image received by the camera system to determine if a selected subject is within the field of view of the camera system.

At step 435, a determination is made as to whether there was a positive match between a region of the most recent image received by the camera system and a visual model corresponding to a selected subject. If a positive match was determined, then the subject detecting module re-initializes the subject tracking module for further tracking, as detailed in step 445. If a positive match was not determined, then the subject detecting module determines that the selected subjects are no longer within the field of view of the camera system and, thus, not available for metering and/or photo capture.

At step 440, a positive match was not determined by the subject detecting module and, therefore, the subject detecting module determines that the selected subjects are no longer within the field of view of the camera system and, thus, not available for metering and/or photo capture.

At step 445, a positive match was determined by the subject detecting module and, therefore, the subject detecting module re-initializes the subject tracking module for further tracking. As such, the tracking module proceeds to perform tracking operations as described in step 415.

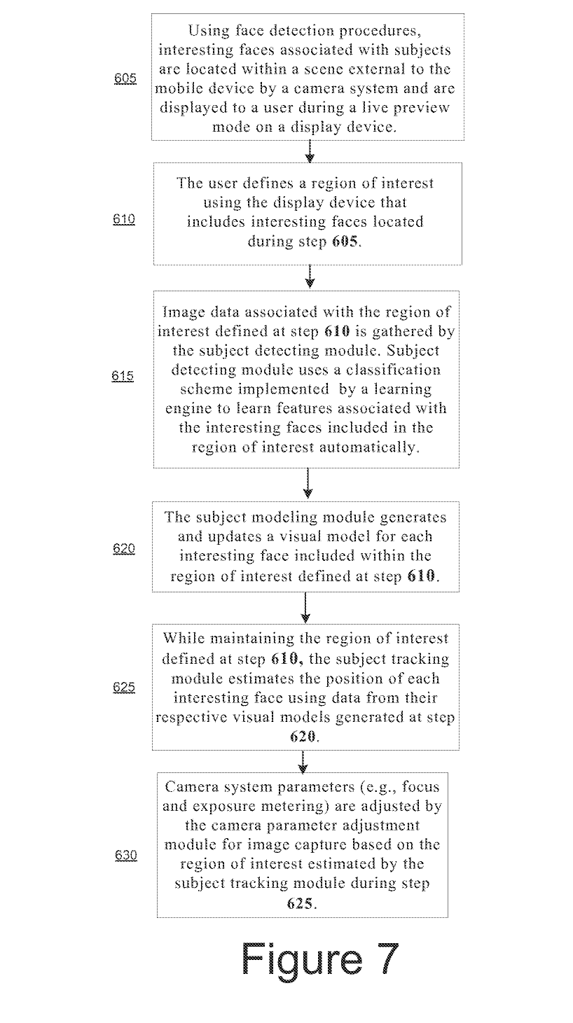

FIG. 7 presents a flowchart which describes an exemplary visual tracking process of interesting faces for use in automatic focusing procedures in accordance with embodiments of the present invention.

At step 605, using face detection procedures, interesting faces associated with subjects are located within a scene external to the mobile device by a camera system and are displayed to a user during a live preview mode on a display device.

At step 610, the user defines a region of interest using the display device that includes interesting faces located during step 605.

At step 615, image data associated with the region of interest defined at step 610 is gathered by the subject detecting module. The subject detecting module uses a classification scheme implemented by a learning engine to learn features associated with the interesting faces included in the region of interest automatically.

At step 620, the subject modeling module generates and updates a visual model for each interesting face included within the region of interest defined at step 610.

At step 625, while maintaining the region of interest defined at step 610, the subject tracking module estimates the position of each interesting face using data from their respective visual models generated at step 620.

At step 630, camera system parameters (e.g., focus and exposure metering parameters) are adjusted by the camera parameter adjustment module for image capture based on the region of interest estimated by the subject tracking module during step 625.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system.

These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above disclosure. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A method of adjusting camera parameters for image capture using a mobile device, said method comprising:
using a camera system, selecting a subject within a field of view of said mobile device during a first time period;
generating and storing a visual model on said mobile device responsive to said detecting of said subject, wherein said visual model is operable to represent said subject during a second time period wherein said subject is outside of said field of view of said mobile device;
estimating a region of interest for capturing an image of said subject during a third time period by tracking said subject in real-time using said visual model, wherein said subject is within said field of view of said mobile device during said third time period; and
adjusting camera parameters responsive to said region of interest prior to image capture.

2. The method as described in claim 1, further comprising capturing an image using said camera parameters.

3. The method as described in claim 1, wherein said detecting further comprises defining a region of interest using user input, wherein said region of interest encapsulates said subject.

4. The method as described in claim 1, wherein said detecting further comprises using a classification scheme to detect said subject, wherein said classification scheme is a Ferns classification scheme.

5. The method as described in claim 1, wherein said camera parameters comprise focus and exposure metering parameters.

6. The method as described in claim 1, wherein said generating further comprises updating said visual model in real-time responsive to appearance changes associated with said subject detected over a period of time.

7. The method as described in claim 1, wherein said tracking further comprises calculating a confidence score, wherein said tracking further comprises determining whether said visual model is updated with new data within an estimated region of interest.

8. The method as described in claim 1, wherein said detecting further comprises using face detection procedures to detect said subject.

9. A system for adjusting camera parameters for image capture using a mobile device, said system comprising:
a detection module operable to detect a preselected subject identified using user input, wherein said preselected subject is within a field of view of said mobile device during a first time period;
a model generation module operable to generate and store a visual model in memory resident on said mobile device responsive to a detection of said preselected subject, wherein said visual model is operable to represent said preselected subject during a second time period wherein said preselected subject is outside of said field of view of said mobile device;
a tracking module operable to estimate a region of interest for capturing an image of said preselected subject during a third time period by tracking said preselected subject in real-time using said visual model, wherein said preselected subject is within said field of view of said mobile device during said third time period; and
an adjustment module operable to adjust camera parameters responsive to said region of interest prior to image capture.

10. The system as described in claim 9, further comprising an image capture module operable to capture an image using said camera parameters.

11. The system as described in claim 9, wherein said detection module is further operable to receive data associated with a region of interest defined by a user, wherein said region of interest encapsulates said preselected subject.

12. The system as described in claim 9, wherein said detection module is further operable to use a classification scheme to detect said preselected subject, wherein said classification scheme is a Ferns classification scheme.

13. The system as described in claim 9, wherein said camera parameters comprise focus and exposure metering parameters.

14. The system as described in claim 9, wherein said tracking module is further operable to calculate a confidence score to determine whether to update a previously estimated focus position calculated for said preselected subject using updated coordinate data provided by said visual model.

15. A method of capturing an image using a mobile device, said method comprising:
using a camera system, detecting a first subject within a field of view of said mobile device during a first time period;
generating and storing a first visual model on said mobile device responsive to a detection of said first subject, wherein said first visual model is operable to dynamically represent said first subject during a second time period wherein said first subject is outside of said field of view of said mobile device;
estimating a first focus position for capturing an image of said first subject during a third time period by tracking said first subject in real-time using said first visual model, wherein said first subject is within said field of view of said mobile device during said third time period;
adjusting camera parameters responsive to said first optimal focus position prior to image capture; and
capturing said image using said camera parameters.

16. The method as described in claim 15, wherein said detecting further comprises defining a region of interest using user input, wherein said region of interest encapsulates said first subject.

17. The method as described in claim 15, wherein said detecting further comprises using a classification scheme to detect said first subject, wherein said classification scheme is a Ferns classification scheme.

18. The method as described in claim 15, wherein said camera parameters comprise focus and exposure metering parameters.

19. The method as described in claim 15, wherein said generating further comprises updating said first visual model in real-time responsive to appearance changes associated with said first subject detected over a period of time.

20. The method as described in claim 15, wherein said tracking further comprises calculating a confidence score to determine whether to update a previously estimated focus position calculated for said first subject using updated coordinate data provided by said first visual model.

21. The method as described in claim 15, further comprising:
using said camera system, detecting a second subject within said field of view of said mobile device during said first time period;
generating and storing a second visual model on said mobile device responsive to a detection of said second subject, wherein said second visual model is operable to represent said second subject during said second time period wherein said second subject is outside of said field of view of said mobile device;
estimating a second focus position for capturing an image of said second subject during said third time period by tracking said second subject in real-time using said second visual model, wherein said second subject is within said field of view of said mobile device during said third time period; and
adjusting camera parameters responsive to said second focus position prior to said image capture.
